(19) United States
(12) Patent Application Publication
(10) Pub. No.: US 2017/0209837 A1
(43) Pub. Date: Jul. 27, 2017

(54) SELF-HEALING MEMBRANES FOR POLYMER ELECTROLYTE APPLICATIONS

(71) Applicants: Liang WANG, Newark, DE (US); Ajay K. PRASAD, Newark, DE (US); Suresh G. ADVANI, Newark, DE (US); William B. JOHNSON, Newark, DE (US)

(72) Inventors: Liang WANG, Newark, DE (US); Ajay K. PRASAD, Newark, DE (US); Suresh G. ADVANI, Newark, DE (US); William B. JOHNSON, Newark, DE (US)

(73) Assignee: University of Delaware, Newark, DE (US)

(21) Appl. No.: 15/500,554

(22) PCT Filed: Jul. 30, 2015
(86) PCT No.: PCT/US2015/042847

§ 371 Date: Jan. 31, 2017

Related U.S. Application Data
(60) Provisional application No. 62/032,084, filed on Aug. 1, 2014.

(51) Int. Cl. B01D 69/14; B01D 65/10; H01M 8/1081; H01M 10/058; H01M 2/14; H01M 8/1046

(52) U.S. Cl. CPC B01D 69/141; H01M 2/14; H01M 8/1046; H01M 8/1081; H01M 10/058; B01D 65/108

(57) ABSTRACT

A self-healing composite membrane includes a continuous ionomer phase in which is dispersed a plurality of hollow fibers and/or microcapsules each containing a liquid healing agent that includes a dispersion or solution of a healing ionomer in a liquid vehicle. Electrochemical devices employing the self-healing composite membranes are provided.

### CROSS REFERENCE TO RELATED APPLICATIONS

This application claims priority benefit of U.S. Appin. No. 62/032,084, filed 1 Aug. 2014, the entirety of which application is incorporated herein by reference for all purposes.

### BACKGROUND OF THE INVENTION

Polymer electrolyte membranes are widely used in fuel cells, where they mediate the flow of charged particles during cell operation. However, the limited mechanical durability of such membranes adversely impacts the life of fuel cells and is a key barrier to fuel cell commercialization. Over their lifetime, the membranes suffer from mechanical and chemical degradation, leading to defects like pinholes and tears which destroy their functionality. Therefore, improvements in polymer electrolyte membrane durability would be of significant commercial value.

### SUMMARY OF THE INVENTION

The invention provides a self-healing composite membrane including a is continuous ionomer phase in which is dispersed a plurality of hollow fibers and/or microcapsules each containing a liquid healing agent that includes a dispersion or solution of a healing ionomer in a liquid vehicle. The invention also provides electrochemical devices employing the self-healing composite membranes.

### BRIEF DESCRIPTION OF THE DRAWINGS

FIG. 1 is a photograph of a micropipette containing a liquid healing agent in a composite membrane according to the invention, before rupture.

FIG. 2 is a photograph of a micropipette in the composite membrane shown in FIG. 1 after rupture.

FIG. 3 is a photograph of a micropipette in the composite membrane shown in FIGS. 1 and 2 after self-healing.

FIG. 4 is a photograph of a hollow polymer fiber containing a liquid healing agent in a composite membrane according to the invention, before rupture.

FIG. 5 shows the hollow polymer fiber of FIG. 4 after rupture.

FIG. 6 shows the hollow polymer fiber of FIGS. 4 and 5 after the composite membrane has self-healed.

FIG. 7 is an SEM image of hollow urea-formaldehyde microcapsules suitable for containing a liquid healing agent according to the invention.

FIG. 8 is an SEM image of a urea-formaldehyde (UF) microcapsule cut by a focused ion beam (FIB), revealing its hollow structure.

FIG. 9 shows photographs of a cluster of uncrushed microcapsules (top pane) and crushed microcapsules (bottom pane) containing a dyed NAFION® solution.

FIG. 10 shows fuel cell performance of a NAFION® membrane, a 6 wt % UF/NAFION® membrane, and a 10 wt % NAFION® membrane, all at 70° C. and 100% relative humidity.

FIG. 11 shows results of accelerated durability testing over 220 hours of a 6 wt % UF/NAFION® membrane at 90° C., using an OCV hold with a relative humidity cycling protocol.

FIG. 12 is a schematic representation of a hydrogen fuel cell using a self-healing composite membrane as the electrolyte/membrane layer according to the invention.

FIG. 13 is a schematic representation of a water electrolyzer using a self-healing composite membrane as the electrolyte/membrane layer according to the invention.

### DETAILED DESCRIPTION OF THE INVENTION

The invention provides a novel self-healing composite membrane that includes a continuous ionomer phase that forms the membrane matrix, in which is dispersed a plurality of carrier vessels containing a liquid healing comprising a dispersion or solution, in a suitable liquid vehicle, of a healing ionomer having the same or similar composition as the continuous ionomer phase of the membrane. The carrier vessels are in the form of hollow fibers and/or microcapsules. When the membrane is stressed during operation to the point that pinholes or cracks initiate, the carrier vessels in the immediate neighborhood of the defect rupture and release the contained polymer dispersion/solution, providing in situ healing of the pinholes and cracks.

### Continuous Ionomer Phase

Any ionomer that transports cations or anions is suitable for forming the continuous ionomer phase according to the invention. Non-limiting examples include fluorinated sulfonic acid co-polymers of tetrafluoroethylene and any fluorinated polymer containing an acidic or basic group, preferably a sulfonic acid group for cation-transporting ionomers; or fluorinated hydrocarbon co-polymers of aromatic or linear polymers and a fluorinated polymer containing an acidic or basic group, preferably sulfonic acid for cation ionomers; or hydrocarbon polymers of aromatic or linear polymers with an acidic or basic group. One particularly desirable cation-transporting ionomer for use according to the invention comes from the class of perfluorosulfonic acid (PFSA) polymers commonly known by the tradename NAFION®. These and other ionomers bearing acidic substituents may be used in proton exchange membrane (PEM) fuel cells, electrolyzers, and other applications. Anion-transporting ionomers include quaternary ammonium or quaternary phosphonium substituents, and these may be used in hydroxide exchange membrane (HEM) fuel cells, electrolyzers, and other applications. Suitable dispersible alkaline ionomers for making anion-transporting membranes are available from Tokuyama Co, Japan under the names A3 ver.2 and AS-4.

Examples of commercial alkaline anion exchange membranes are sold by Tokuyama Co, Japan under the names AHA A010, A201. Other examples include commercial alkaline anion exchange membranes such as Morgane ADP (Solvay S.A.), Tosflex® SF-17 (Tosoh) and 2259-60 (Pall RAI). Any of these can be dissolved in suitable solvents, and the resulting solutions combined with carrier vessels loaded with liquid healing agent and used to cast composite membranes according to the invention.

The continuous ionomer phase may consist of the ionomer. Or, it may additionally contain any of a number of additives known in the art for preparing membranes. Non-limiting examples include CeO₂ and MnO₂ nanoparticles, as well as hydrophilic inorganic particles (e.g., SiO₂ and TiO₂) and carbon nanotubes or porous PTFE reinforcing structures. Heteropolyacids may also be included, for example to improve proton conductivity.

### Carrier Vessels

Carrier vessels may for example be any one of the following, either singly or in combination: hollow microfibers, microcapsules, glass tubes, micropipettes, or any other structure that is substantially impermeable to the contents of the vessels and to any solvents used to cast the continuous ionomer phase. Generally, the contents are completely encapsulated such that the vessels must be ruptured for any outflow of liquid healing agent to occur.

It is desirable that it be possible to rupture the carrier vessels upon exposure to one or more stresses. The rupture may result from mechanical stresses and be due to inherent material properties, for example being brittle, or because of design, for example having very thin walls. Or, the stresses may be thermal. For example, the carrier vessels may be designed to rupture when the temperature exceeds normal fuel cell operating temperatures, which are typically 60-80° C., or when the temperature falls low enough to damage the fuel cell, typically about −40° C.

The vessels, whether hollow fibers or microcapsules, can be made from a range of materials, including but not limited to polymers, for example polytetrafluoroethylene (PTFE), polyether ether ketone (PEEK), or fluorinated ethylene propylene (FEP); ceramics, for example glass or alumina; and metals, for example platinum, iron or silver.

If the carrier vessels are hollow fibers, they may be randomly oriented in the membrane or they may be oriented along one or more defined axes. For example, they may all be disposed parallel to a single axis, or some may be disposed parallel to one axis and the rest disposed to a different an axis, e.g., one orthogonal to the first. Such placements can be effected manually, if needed, although more automated methods are preferred.

One typical material for forming microcapsules is a urea-formaldehyde condensate. Or, microcapsules having a crosslinked chitosan shell can be prepared by the method described by Liu etc. in Soft Matter, 2011, 7, 4821. Polymethylmethacrylate (PMMA) and polyamide microcapsules can be made using interfacial polycondensation or polymerization, for example as described in Defence Science Journal, Vol. 59, No. 1, January 2009, pp. 82-95. Melamine-formaldehyde microcapsules can be made as described in International Journal of Pharmaceutics, Volume 242, Issues 1-2, 21 Aug. 2002, Pages 307-311. The shell material can also be polytetrafluoroethylene (PTFE), which may be prepared by polymerizing liquid tetrafluoroethylene as described in U.S. Pat. 5,405,923, but doing so in the presence of dispersed droplets of liquid healing agent at a stirring speed selected to provide capsules of the desired size. Shells of polyether ether ketone (PEEK) can be obtained by step-growth polymerization by the dialkylation of bisphenolate salts as generally described in Journal of Polymer Science Part A: Polymer Chemistry, Volume 33, Issue 2, pages 331-344, 30 Jan. 1995. The reaction would be performed in the presence of dispersed droplets of liquid healing agent at a stirring speed selected to provide capsules of the desired size.

Poly(ether sulfone)s and sulfonated poly(ether sulfone)s, may be synthesized by direct polymerization of bisphenols and aromatic dihalides in N-methyl-2-pyrrolidone (NMP) at 130° C., as described in Polym. Adv. Technol. 2006; 17: 591-597. The reaction would be performed in the presence of dispersed droplets of liquid healing agent at a stirring speed selected to provide capsules of the desired size.

The vessels have at least one external dimension less than 2 mm, or less than 1 mm, 500 μm, 250 μm, 150 μm, 100 μm, 50 μm, 30 μm, 20 μm, 10 μm, or 5 μm. Typically, this external dimension will be at least 1 μm. In the case of hollow fibers, these numbers relate to the outside diameter. In the case of oval vessels, this relates to the largest outside circular diameter, or the outside diameter in the case of spherical vessels. The appropriate size can be selected to match the desired membrane thickness for the particular end-use. Larger carrier vessels may be used for thicker membranes, and smaller ones are preferred in applications where thinner membranes are desirable. Typically, the vessels have at least one external dimension that is less than 80% of the membrane thickness, or less than 40% or 20%. For example, when the application demands a thin membrane for performance reasons, for example a membrane thickness of 25 μm, then the lowest outer dimension of the carrier vessel should be less than 20 μm, and preferably less than 10 μm, and most preferably less than 5 μm.

The filled vessels typically constitute at least 1% by weight of the composite membrane, or at least 2%, 3%, 4%, 5% or 6%. They typically constitute at most 20%, or at most 15%, 14%, 13%, 12%, 11% or 10% of the composite membrane.

### Liquid Healing Agent

The liquid healing agent includes a healing ionomer, which is typically the same or similar ionomer as that which forms the continuous ionomer phase of the composite membrane. If the ionomer of the continuous phase is a cation-transporting ionomer, the healing ionomer should transport the same type of cations. Similarly, if the ionomer of the continuous phase is an anion-transporting ionomer, the healing ionomer should transport the same type of anions.

A solvent or other liquid vehicle for the healing ionomer is also included in the liquid healing agent. Typically, although not necessarily, the solvent or other liquid vehicle is volatile enough that, once the liquid healing agent has been released from a carrier vessel, the solvent or vehicle can evaporate from the composite membrane. This may occur at room temperature, or at fuel cell operating temperature (typically 60° C. to 80° C.). Or, it may be extracted from the liquid healing agent by contact with water during operation of the cell. In any case, loss of the solvent or liquid vehicle causes the polymer to solidify and thereby heal nearby defects. Since most fuel cell membrane ionomers are soluble in common solvents (e.g., ethanol, ethylene glycol and tributyl phosphate), liquid vehicles including these (optionally with some water present) may be suitable for preparing dispersions or solutions of the healing ionomer. A crosslinker capable of crosslinking the ionomer in the continuous ionomer phase may also be included in it, optionally with a catalyst for the crosslinking reaction. The crosslinker may also be capable of crosslinking the healing ionomer upon its release from the carrier vessels, although this is not required. One exemplary class of crosslinking agents is polybenzimidazoles, as described in Journal of Power Sources Volume 163, Issue 1, 7 Dec. 2006, Pages 9-17.

The healing ionomer typically constitutes at least 5 wt %, or at least 10, 20 or 30 wt %, of the liquid healing agent. It typically constitutes at most 90 wt %, or at most 80, 70 or 60 wt %, of the liquid healing agent. The balance is the solvent or other liquid vehicle, optionally containing a catalyst and/or crosslinker. If a catalyst and/or crosslinker are present, they together typically constitute from 1 wt % to 5 wt % of the liquid healing agent.

The liquid healing agent may be deposited within the carrier vessel using standard approaches known in the art. For example, for hollow fibers, the liquid healing agent can be drawn in by vacuum. Filled microcapsules can be produced in situ by appropriately controlling the chemistry of the microcapsule during its formation.

### Making the Membranes

Ionomer membranes according to the invention can be prepared using various processes known in the art, including but not limited to solution casting or extrusion. The carrier vessel is incorporated with the ionomer prior to membrane preparation using standard mixing approaches known in the art, including but not limited to stirring or other blending approaches for particulate-like materials. Fibrous, mat-like, or microcapsule carrier vessels can typically be used directly and the membranes formed using standard pre-preg or solution methods. Care must be taken during membrane preparation not to damage the carrier vessel, which would potentially allow the liquid healing agent contained within it to prematurely leak out during preparation. The ionomer membrane is then formed in the desired thickness. Solution casting is particularly preferable because it does not unduly stress the carrier vessels, and can be used to easily prepare a range of membrane thicknesses, from a few pm up to 2 mm or more. The particular membrane preparation parameters used depend on the ionomer, and are well known in the art. For example, for PFSA-based ionomers using alcohol solvents, membranes can be solution cast between room temperature and 80° C., and subsequently dried in air from room temperature to 150° C.

Suitable casting solvents are known to the skilled person, and non-limiting examples include dimethylacetamide, dimethylformamide, N-Methyl-2-pyrrolidone and dimethyl sulfoxide. Solutions of NAFION® polymer in any of these solvents can be prepared by evaporating the water/alcohol solvent from a commercial NAFION® solution and re-dissolving the polymer in the selected solvent.

Membranes according to the invention typically have a thickness of at least 1 μm, or at least 2, 5 or 10 μm. The thickness is typically at most 5000 μm, or at most 4000, 3000, 2000, 1000, 500, 250, 100 or 50 μm. Typically, the length and width of the membrane are each independently at least 10 times the thickness, or at least 20, 50 or 100 times the thickness. These same values apply to the diameter, if the membrane is circular.

### Devices Employing the Membranes

Ionomer membranes according to the invention can be used in a variety of applications where durable, ionomer membranes are required. The membranes require no special handling after preparation. During use, should the ionomer membrane be stressed due to mechanical stresses, thermal stresses, chemical stresses, or suffer other physical damage, the carrier vessel within the ionomer membrane will rupture and release the liquid healing agent contained within it, thereby mitigating the effects from the outside stresses. For example, if a crack or hole is formed in the ionomer membrane, the liquid healing agent contained in the carrier vessel will be released and can fill the hole or blunt the crack tip, thereby increasing the durability of the ionomer membrane. Typical uses of the inventive membrane include, but are not limited to fuel cells, batteries, sensors, or any other electrochemical application where durable membranes capable of ion transport are required. These may include, but are not limited to, redox flow batteries, zinc-air batteries and other metal-air batteries, solar hydrogen devices, desalination devices, and electrodialysis devices. The skilled person will be aware of how to incorporate the membranes in these devices.

### Fuel Cells and Electrolyzers Using Self-Healing Membranes

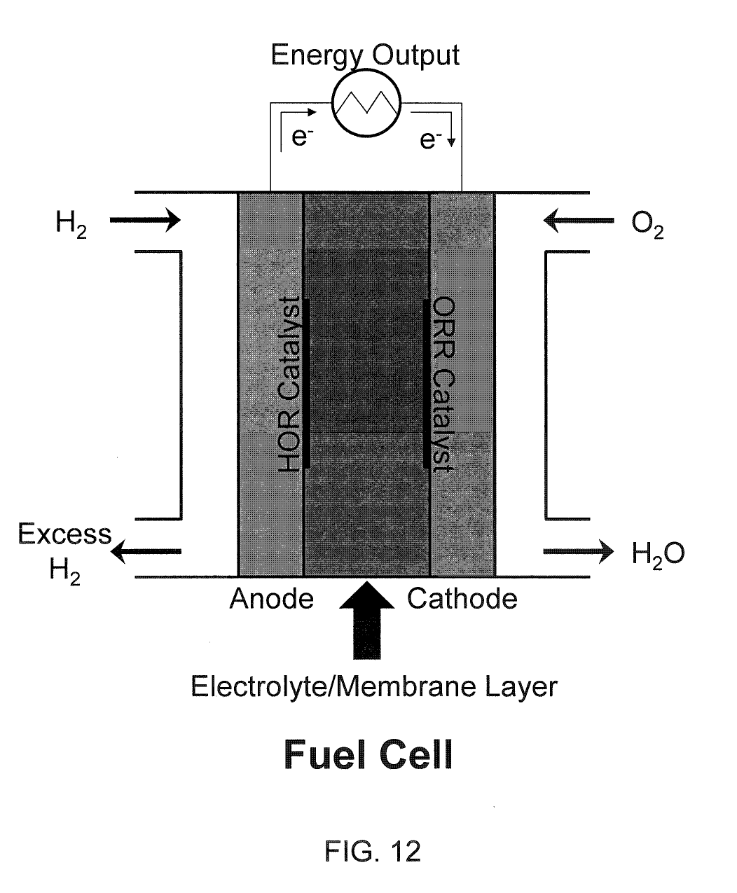

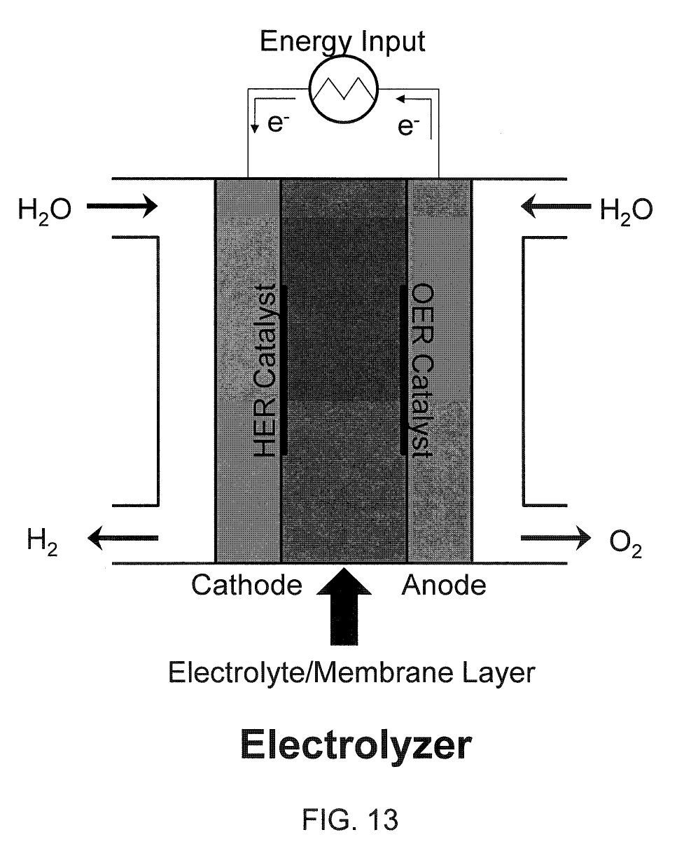

In some embodiments of the invention, self-healing membranes may be used in hydrogen fuel cells or water electrolyzers. Numerous configurations and methods of making hydrogen fuel cells and water electrolyzers and are known to the skilled person, and self-healing membranes according to the invention may be used as electrolytes/membranes in any of these. Schematic representations of a fuel cell and an electrolyzer are shown in FIGS. 12 and 13, respectively. In these drawings, HER refers to hydrogen evolution reaction, OER refers to oxygen evolution reaction, HOR refers to hydrogen oxidation reaction, and ORR refers to oxygen reduction reaction. Suitable examples of catalysts for each of these reactions are known to the skilled person.

Self-healing membranes may also be used in fuel cells using fuels other than hydrogen. They may also be used in membranes for other electrochemical devices and processes including, but not limited to, batteries, for example redox flow batteries, zinc-air batteries and other metal-air batteries, solar hydrogen devices, desalination devices, sensors, electrodialysis devices, or any other electrochemical application where durable membranes capable of ion transport are required. The skilled person will be aware of how to incorporate the membranes in these devices.

### EXAMPLES

Three sets of experiments to demonstrate the self-healing concept are described below. The first set pertains to the use of a carrier vessel consisting of a mm-scale micropipette. The second corresponds to a carrier vessel consisting of a 100 μm-scale FEP hollow polymer fiber. The third corresponds to a 5 μm urea-formaldehyde microcapsule. All references to NAFION® polymer in the Examples refer to perfluorosulfonic acid polymer having an equivalent weight of 1000EW. This polymer is sold as a 5 wt % solution in alcohol/water by DuPont under the name NAFION® D520 1000EW.

### Example 1

### Carrier Vessels Formed from Micropipettes

A composite membrane was prepared, incorporating a carrier vessel consisting of a micropipette (IDEX Health & Science LLC, 1.5 mm OD and 1 mm ID, PEEK) filled with NAFION® D520 1000EW. The micropipette was filled using a mild vacuum applied by a rubber bulb. A few drops of a dark dye (STEEL BLUE® Layout Fluid, Dykem) were added to the solution prior to filling the micropipette. The dye was included to allow high-contrast photographs to be taken later. The ends of the micropipette were then sealed with epoxy (3M, DP460NS) and allowed to harden. The resulting micropipette was laid flat on a surface and NAFION® D520 1000EW was cast over it and allowed to dry slowly over 24 hours. The resultant membrane was a pore-free solid film about 2 mm thick with an embedded micropipette filled with NAFION® solution.

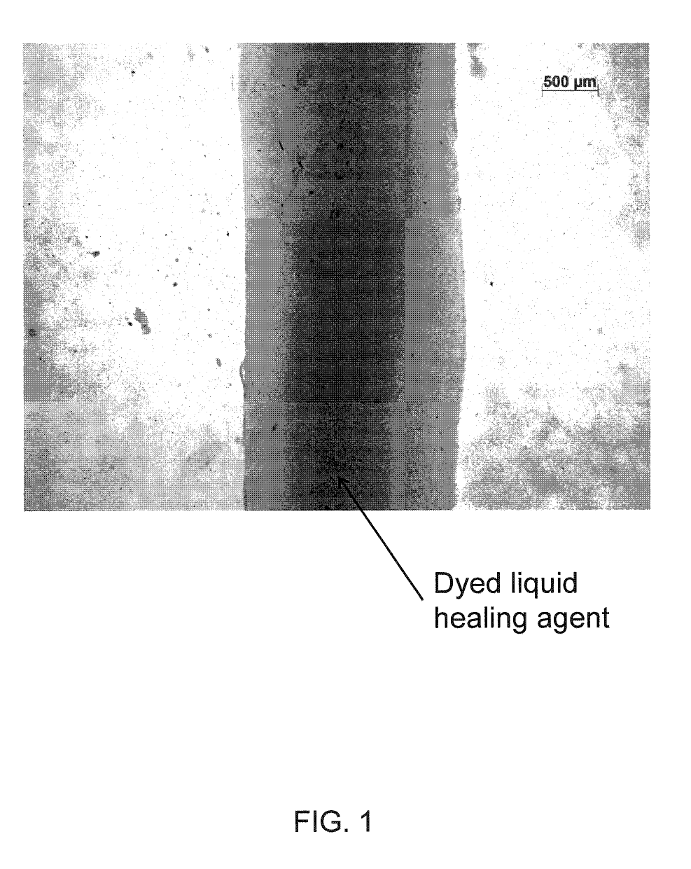

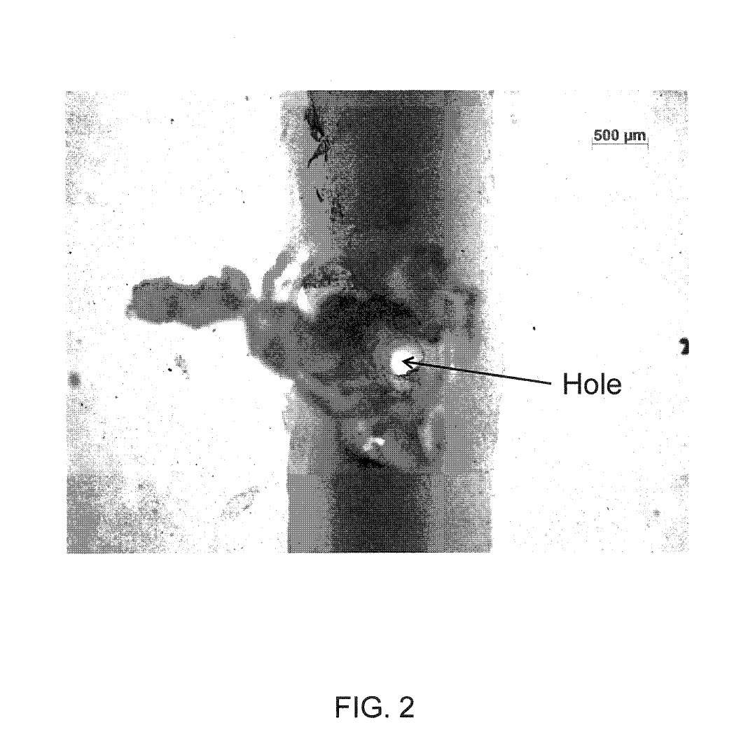

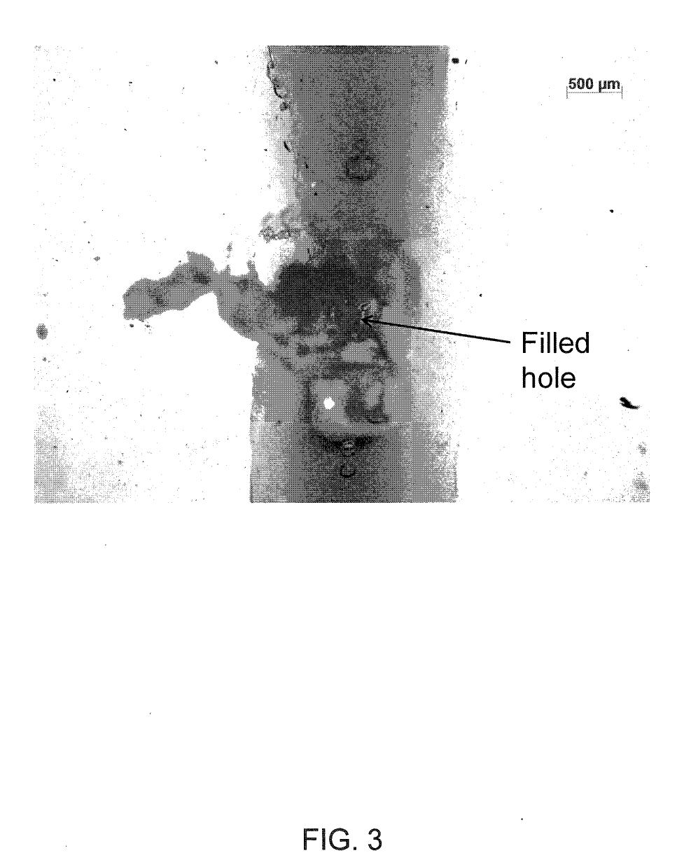

To simulate defects that might occur during fuel cell operation, the membrane is was subjected to mechanical damage by manually rupturing the micropipette by drilling into it with 0.3 mm drill. FIGS. 1 and 2 show the micropipette before and after drilling, respectively. In FIG. 2, the hole is rendered visible by having the same light color as the membrane surrounding the micropipette. Fuel cell operation (60° C.-150 C.) was then simulated by applying heat to one end of the composite membrane, causing the solution to emerge from the micropipette. The result was that the hole was filled with ionomer solution, as observed by the hole becoming dark like the rest of the solution in the micropipette (FIG. 3). After subsequent drying, the hole was completely filled and sealed with ionomer, thus healing the defect.

### Example 2

### Carrier Vessels Formed from 100 μm FEP Hollow Polymer Fibers

A composite membrane was prepared, incorporating hollow polymer fibers (Paradigm Optics, 125 μm OD and 100 μm ID, FEP) filled with NAFION® D520 1000EW. The fibers were filled by capillary action. A few drops of red liquid dye (Rit) were added to the solution prior to filling the fibers, to allow high-contrast photographs to be taken. The ends of the fibers were then melted and sealed over an open flame. The resulting fibers were laid flat on a surface and NAFION® D520 1000EW was cast over it and allowed to dry slowly over 24 hours. The resultant membrane formed a pore-free solid film that was about 135 μm thick and incorporated the fibers filled with NAFION® solution.

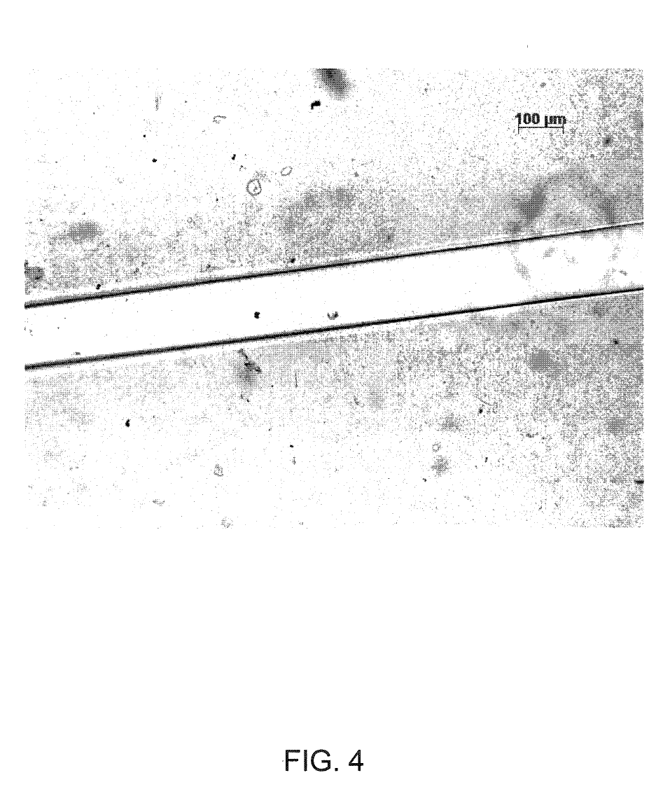

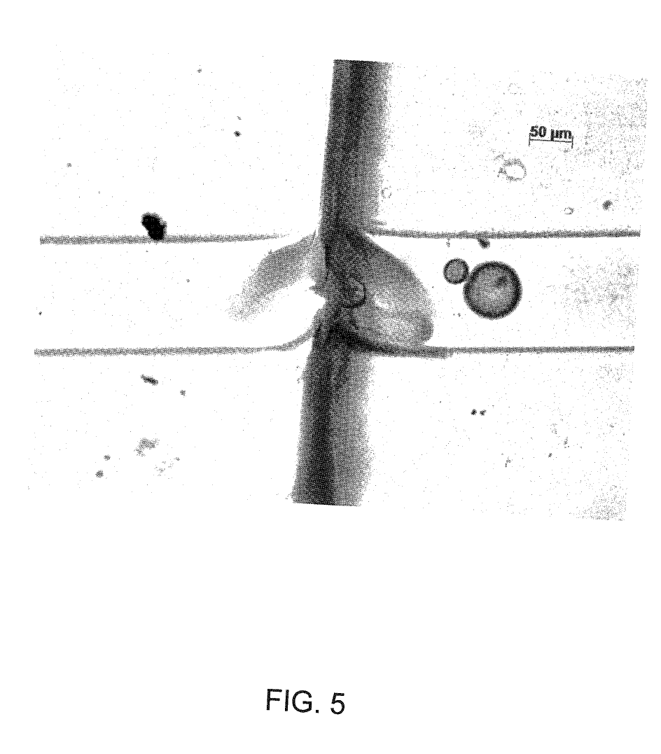

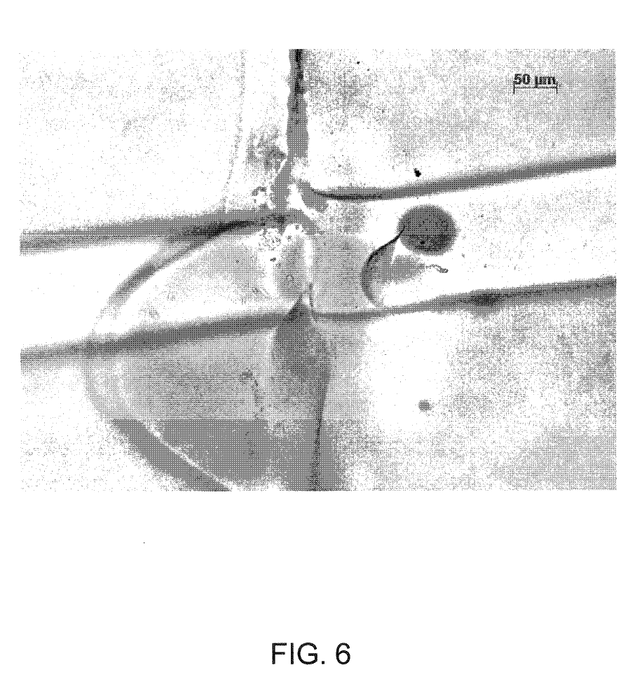

To simulate defects that might occur during operation, the membrane was subjected to mechanical damage by cutting it with a blade such that one or more of the filled fibers were cut. FIGS. 4 and 5 show one of the fibers before and after cutting. In FIG. 5, the long black vertical line is the crack in the membrane resulting from the cutting. Fuel cell operation (60° C.-150° C) was then simulated by applying heat to the composite membrane, causing the healing liquid to emerge from the fibers and fill the crack. After subsequent drying, only traces of the crack remained, seen as the thin black vertical line at the very top of FIG. 6. Thus, the solution effectively healed the defect.

### Example 3

### Composite Membrane Using 5 μm Urea-Formaldehyde Microcapsules

Microcapsules containing a liquid healing agent were prepared as follows. A 300 mL beaker containing 100 mL of water and equipped with a thermocouple and a stirring blade was set on hot plate. To this was added 1.25 g urea (Aldrich), 0.125 g ammonium chloride and 0.125 g resorcinol. The solution was stirred by blade at 1000 rpm for 10 minutes to provide a homogenous solution, and then 20 mL of a 5 wt % solution of NAFION® polymer in tributyl phosphate was added with continued stirring to form an oil-in-water emulsion. The stirring speed was set at 1000 rpm to obtain the desired microcapsule size. The pH was adjusted to 3.5 with 20% NaOH, followed by addition of 3.165 g of 37% formaldehyde (Aldrich). After 30 minutes of stirring, the beaker was covered with plastic film. Then the mixture was brought to 50° C. and then maintained at that temperature for 4 hours. The resulting microcapsules were then separated by filtering and dried.

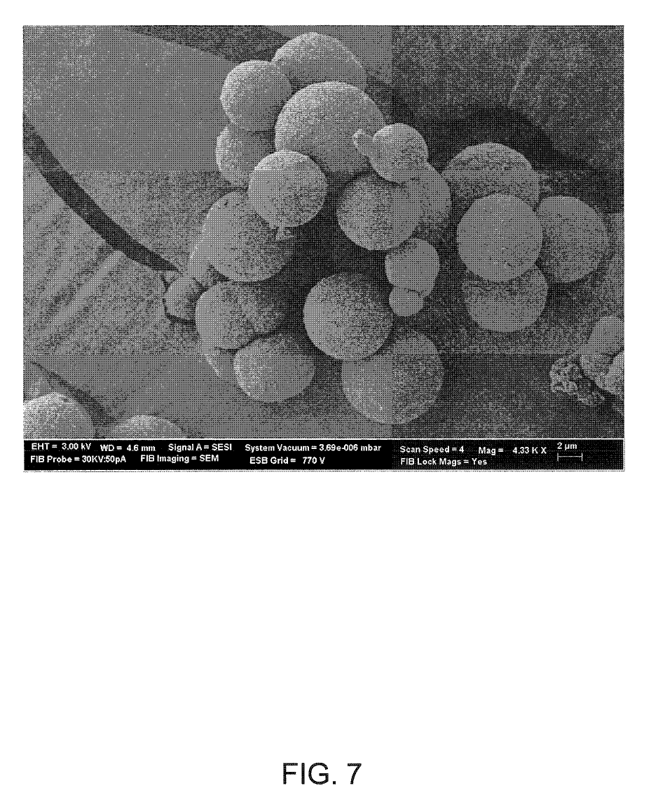

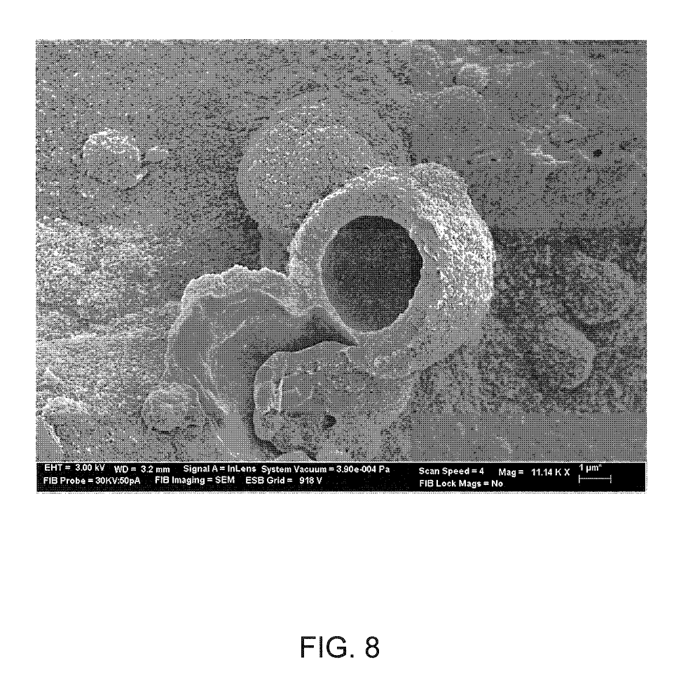

FIG. 7 shows SEM images of the resulting UF microcapsules, which ranged in diameter from 2 to 10 μm with an average size of 5.85 μm. FIG. 8 reveals the hollow structure of a typical microcapsule, exposed by cutting it with a focused ion beam.

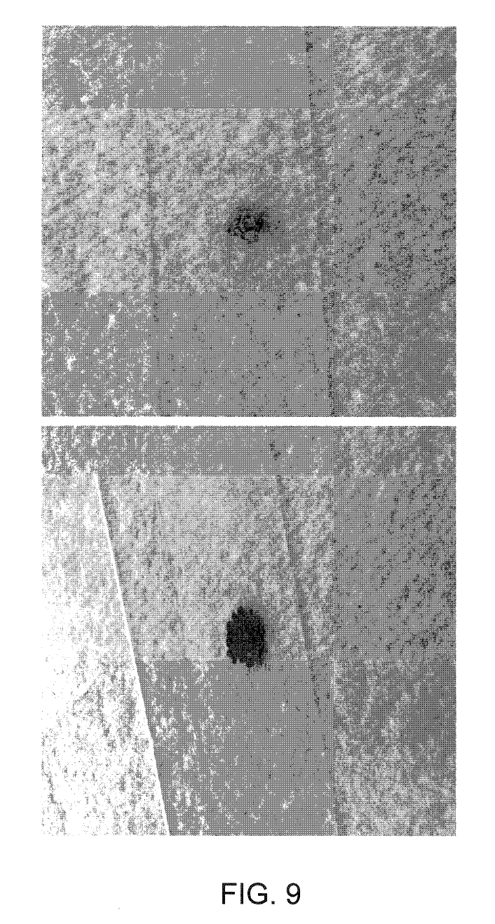

To verify that hollow microcapsules prepared by this method were indeed filled with NAFION® solution, a batch of microparticles was prepared in which the solution of NAFION® polymer in tributyl phosphate was dyed dark blue with STEEL BLUE® Layout Fluid (Dykem). The resulting particles were isolated and dried for at least a week under ambient conditions. A small portion of the dried microcapsules was then placed between two clean, dry glass slides. The upper pane of FIG. 9 shows a cluster of the microcapsules prior to applying finger pressure, which crushed the microcapsules and released the dyed liquid healing agent, as seen by the increased size of the dark spot in the lower pane of FIG. 9. This confirms that the microcapsules had been successfully filled with the NAFION® solution, which was released by mechanical damage.

To form a composite membrane according to the invention, microcapsules prepared as described above (without the dye) were added at various loadings (0 wt %, 6 wt % and 10 wt %) to 5 wt % solutions of NAFION® polymer in dimethylacetamide, and each mixture was poured into a casting frame to cast a membrane and allowed to dry slowly at 60° C. over 24 hours. The resulting membranes were pore-free solid films about 50 μm thick, with the 0 wt % membrane serving as a control.

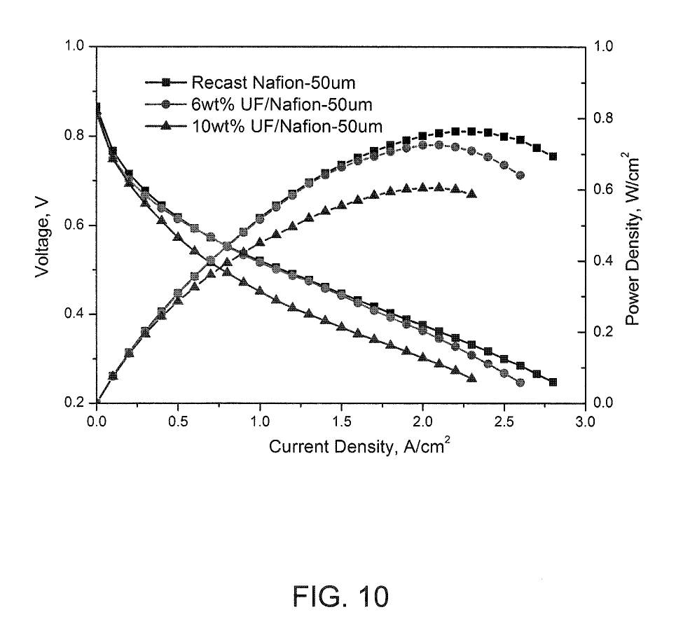

The fuel cell performances of the 0 wt %, 6 wt % and 10 wt % microcapsule membranes were tested in a 10 cm² cell at 70° C. and 100%RH, with H₂ and O₂ flow rates of 200 and 400 mL/min, respectively. As shown in FIG. 10, fuel cell performance of the 6 wt % microcapsule membrane compared well with that of the baseline 0 wt % membrane, but performance of the 10 wt % membrane was significantly worse than that of the baseline membrane. This suggests that, in this particular embodiment, the 10 wt % microcapsule loading was too high to be optimal.

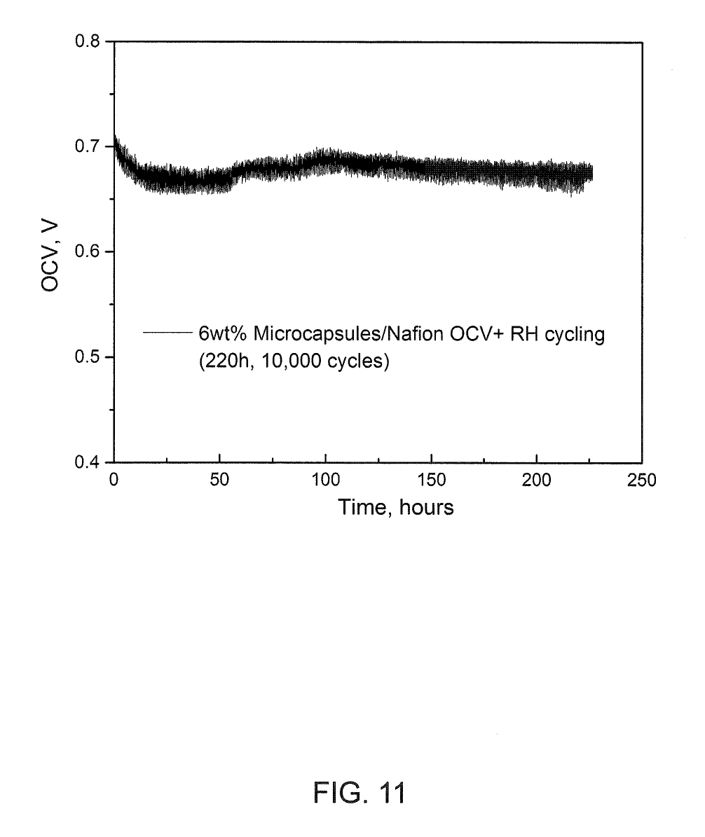

Accelerated durability testing of the 6 wt % microcapsule membrane was conducted at 90° C., using an OCV hold with RH cycling protocol. Each RH cycle consisted of a 30 second wet step followed by a 45 second dry step. This protocol was designed to simultaneously generate both chemical degradation (OCV hold) and mechanical degradation (RH cycling). As shown in FIG. 11, the 6 wt % microcapsule membrane showed stable OCV over the entire 220 hours (10,000 cycles) test.

Although the invention is illustrated and described herein with reference to is specific embodiments, the invention is not intended to be limited to the details shown. Rather, various modifications may be made in the details within the scope and range of equivalents of the claims without departing from the invention.

1. A self-healing composite membrane comprising a continuous ionomer phase in which is dispersed a plurality of hollow fibers and/or microcapsules each containing a liquid healing agent that comprises a dispersion or solution of a healing ionomer in a liquid vehicle.

2. The composite membrane according to claim 1, wherein the composite membrane comprises said plurality of microcapsules.

3. The composite membrane according to claim 2, wherein the microcapsules are urea-formaldehyde microcapsules.

4. The composite membrane according to claim 1, wherein the composite membrane comprises said plurality of hollow fibers.

5. The composite membrane according to claim 1, wherein the plurality of hollow fibers are oriented randomly.

6. The composite membrane according to claim 1, wherein some of the plurality of hollow fibers are oriented along a first axis, and the rest are oriented along an axis orthogonal to the first.

7. The composite membrane according to claim 1, wherein the ionomer of the continuous ionomer phase is a cation-transporting ionomer.

8. The composite membrane according to claim 7, wherein the cation-transporting ionomer is a perfluorosulfonic acid polymer.

9. The composite membrane according to claim 1, wherein the ionomer of the continuous ionomer phase is an anion-transporting ionomer.

10. The composite membrane according to claim 9, wherein the anion-transporting ionomer comprises quaternary ammonium groups.

11. The composite membrane according to claim 9, wherein the anion-transporting ionomer comprises quaternary phosphonium groups.

12. The composite membrane according to claim 1, wherein the healing ionomer is the same as the ionomer of the continuous ionomer phase.

13. An electrochemical device employing the composite membrane according to any prcccding claim 1.

14. The electrochemical device according to claim 13, wherein the electrochemical device is a fuel cell.

15. The electrochemical device according to claim 13, wherein the electrochemical device is an electrolyzer.

16. The electrochemical device according to claim 13, wherein the electrochemical device is a battery.

17. The electrochemical device according to claim 13, wherein the electrochemical device is a solar hydrogen device.

18. The electrochemical device according to claim 13, wherein the electrochemical device is a desalination device.

19. The electrochemical device according to claim 13, wherein the electrochemical device is an electrodialysis device.
